(19) United States
(12) Patent Application Publication
(10) Pub. No.: US 2016/0131355 A1
(43) Pub. Date: May 12, 2016

(54) LED LIGHTING ASSEMBLY AND METHOD OF MANUFACTURING THE SAME

(71) Applicant: ONCE INNOVATIONS, INC., Plymouth, MN (US)

(72) Inventor: Zdenko Grajcar, Orono, MN (US)

(73) Assignee: Once Innovations, Inc., Plymouth, MN (US)

(21) Appl. No.: 14/896,021

(22) PCT Filed: Jun. 10, 2014
(86) PCT No.: PCT/US2014/041628

§ 371 Date: Dec. 4, 2015

Related U.S. Application Data
(60) Provisional application No. 61/833,139, filed on Jun. 10, 2013.

(51) Int. Cl. F21V 29/70; F21V 23/00; F21V 23/06; F21K 99/00

(52) U.S. Cl. CPC F21V 29/70; F21K 9/1355; F21V 23/006; F21V 23/06; F21Y 2101/02

(57) ABSTRACT

A light emitting diode lighting assembly having a substrate with a plurality of light emitting diodes disposed thereon that is secured to a heat sink. An elongated flat printed circuit board having a plurality of electronic components thereon for driving the light emitting diodes is disposed through the heat sink and electrically connects with the substrate at a first end and has a head portion with grooved conductive elements that engage the threads of a cap screw at a second end in order to provide an electrical connection from the cap screw to the substrate without requiring solder points.

This application claims the benefit of priority to U.S. Provisional Patent Application Ser. No. 61/833,139, entitled “LED Lighting Assembly and Method of Manufacturing the Same,” which was filed by Z. Grajcar on Jun. 10, 2013, the entire contents of which are incorporated herein by reference.

### BACKGROUND

This invention relates to a light emitting diode (LED) lighting assembly. More specifically this invention relates to an LED lighting assembly designed to eliminate soldering during the manufacturing process.

LED lighting assemblies have gained popularity over the last several years as an energy efficient replacement to an incandescent light bulb. Unlike the typical incandescent light bulb, for an LED lighting assembly to produce light circuitry must be presented to operate the LEDs. This circuitry often is very complex with intricate manufacturing processes including soldering for electrically connecting electrical components. The complex circuitry and intricate manufacturing processes typically cause such LED lighting assemblies to be expensive and prone to malfunction.

Applicant in U.S. Pat. No. 8,373,363 and USSNs 12/824,215, 13/585,806 and 13/715,884 presents solutions to this complex circuitry by presenting circuits that have minimal electrical components. Each of these applications is incorporated in full herein. These references teach that by conditioning current electronic components can be minimized thus allowing a manufacturer to be able to place all of the components on a single substrate, reduce heat sink requirements and greatly reduce costs. Still, for each of these applications the solutions presented result in a manufacturing process that typically requires soldering that can be problematic.

In particular, soldering can cause multiple problems during the manufacturing process. Specifically soldering is a process by which metal is melted to provide an electrical connection between electrical components. This is a process that requires skilled labor and when done incorrectly can provide openings that electricity can “jump” over causing dangerous conditions that include extreme resistance and thus heat. This can provide a condition for malfunctioning in the circuit causing inconsistent flow of current resulting in undesired flicker or in extreme cases potentially fire. Thus a need in the art exists for a design that eliminates complex manufacturing processes such as soldering.

Thus a principle object of the present invention is to provide an LED lighting assembly that minimizes manufacturing error and product failure.

Yet another object of the present invention is to minimize product and manufacturing costs.

These and other objects, advantages and feature will become apparent from the specification and claims.

### SUMMARY OF THE INVENTION

A light emitting diode lighting assembly and a method of manufacturing the same. The assembly has a substrate with a plurality of light emitting diodes (LEDs) disposed about a centrally located socket on the side opposite the LEDs. The substrate is secured to a heat sink and the socket extends into a channel in the heat sink A printed circuit board having a plurality of electronic components thereon for driving the light emitting diodes is disposed through a base element that receives the printed circuit board. The base element specifically has a an annular flange that is of size and shape to frictionally be inserted into the heat sink and a stop member that engages the exterior of the heat sink The threaded member extends from the stop member on the opposite side of the annular flange and has a slot therein that receives a head portion of the printed circuit board that engages the slot. The printed circuit board tapers from the head portion through the base element and through the channel of the heat sink and terminates in tongue elements with electrical leads that insert into the socket of the substrate to provide an electrical communication path between the substrate and printed circuit board. A screw cap is threadably connected to both the base element and printed circuit board thus causing conductive elements of the printed circuit board to engage the screw cap to provide an electrical connection from the screw cap to the light emitting diodes.

### BRIEF DESCRIPTION OF THE DRAWINGS

FIG. 1 is a plan view of a printed circuit board for an LED lighting assembly;

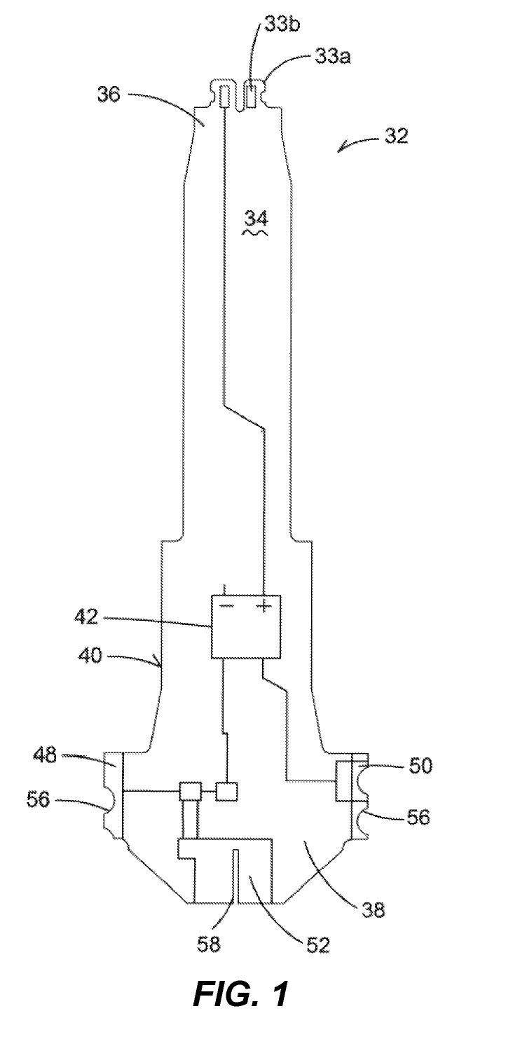

FIG. 2 is a sectional view of an LED lighting assembly;

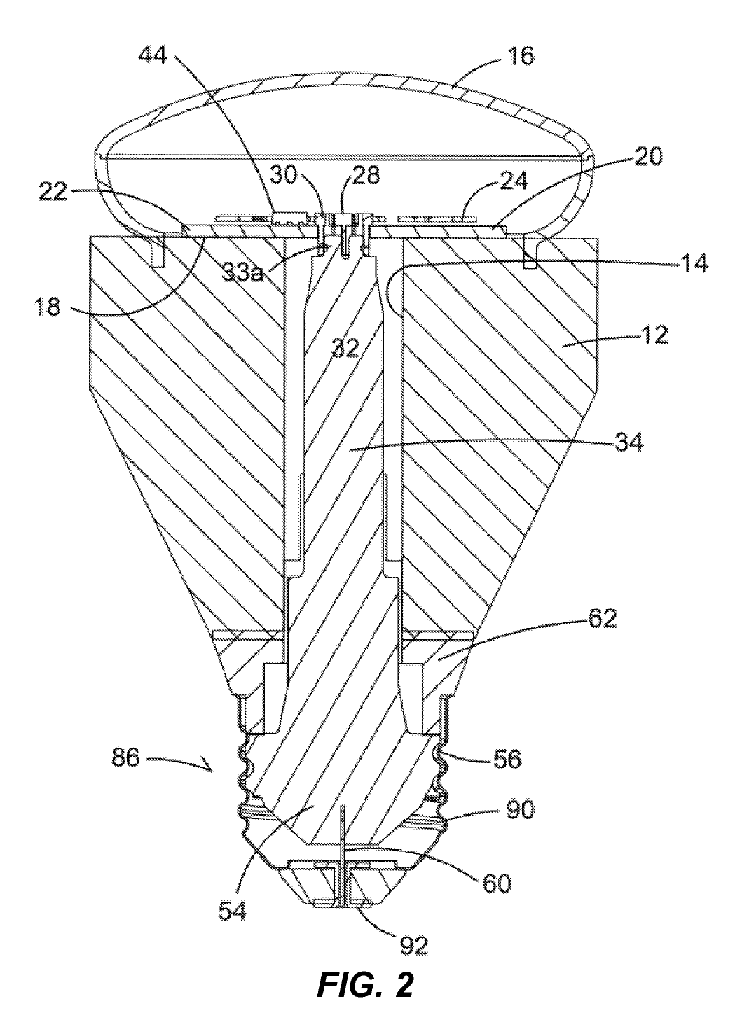

FIG. 3 is a side plan view of an LED lighting assembly;

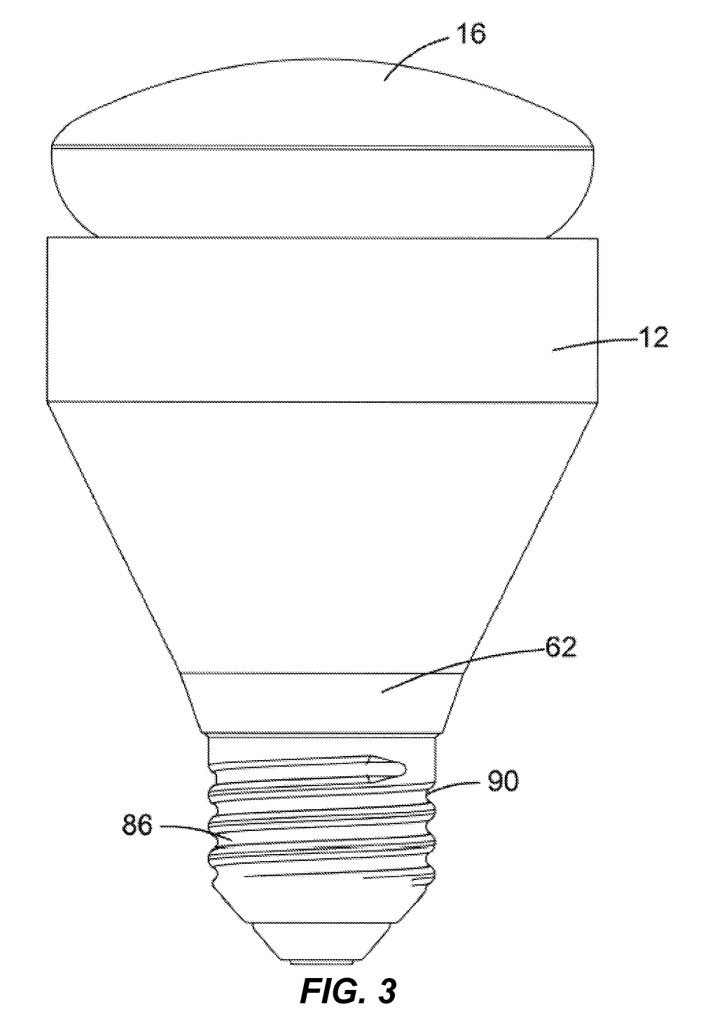

FIG. 4 is a perspective of a base element of an LED lighting assembly;

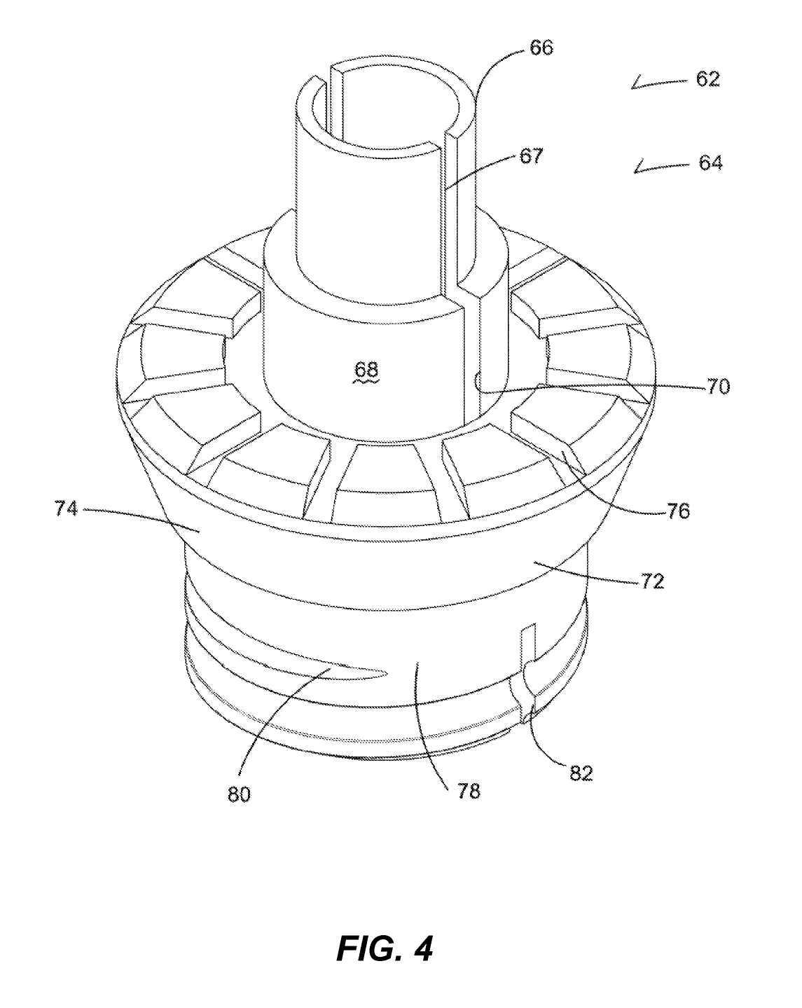

FIG. 5 is a top plan view of a base element of an LED lighting assembly;

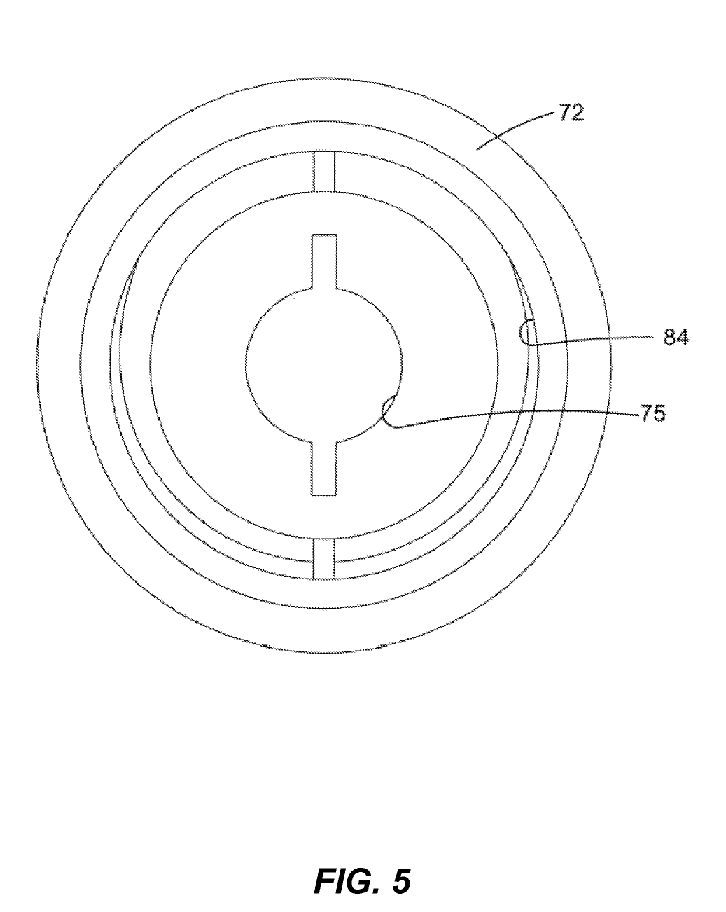

FIG. 6 is an exploded perspective view of an LED lighting assembly.

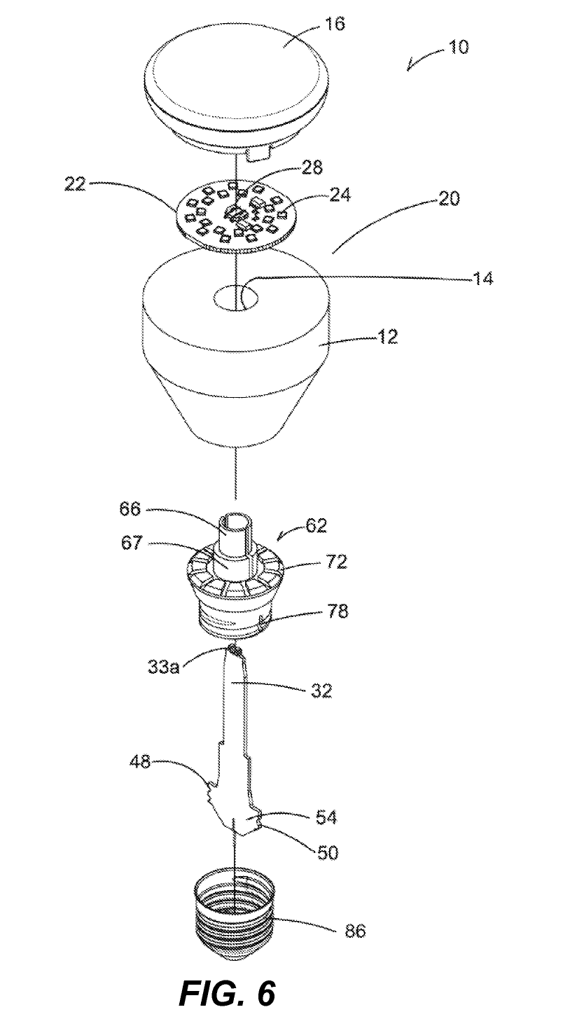

### DETAILED DESCRIPTION OF A PREFERRED EMBODIMENT

The figures show an LED lighting assembly 10 that in a preferred embodiment is in an A-19 form factor. The lighting assembly 10 includes a heat sink 12 having a channel 14 disposed therethrough that in one embodiment is slotted. The heat sink 12 receives a bulb assembly 16 in any way as is known in the art and has a surface 18 at a first end that receives a platform assembly 20. The heat sink 12 and bulb assembly 16 can be of any type or shape and not fall outside the scope of this disclosure.

The platform assembly 20 includes a substrate 22 that contains a plurality of light emitting diodes (LEDs) 24 that emit light through the bulb assembly 16. Disposed through a central opening 26 is an electrically conductive device 28 that in one embodiment can have openings 30 therein for receiving, centering and securing the bulb assembly 16 therein. The electrically conductive device 28 has leads within sockets 31 that receive a printed circuit board 32 and preferably tongue elements 33a that similarly have electrical leads 33b. In this manner the device 28 is electrically connected to the printed circuit board 32.

The printed circuit board 32 has an elongated body 34 that is flat and formed to matingly fit through the channel 14 to be disposed through the heat sink 12. The elongated body 34 extends from a first end 36 where the printed circuit board 32 is electrically connected to the electrically conductive device 28 to a second end 38 having a plurality of electronic components 40.

The plurality of electronic components 40 includes a rectifier 42, transistors 44 and resistors 46 to condition current from an AC power source and in embodiments presents the circuits shown and described in full in U.S. Pat. No. 8,373,363 and U.S. patent application Ser. Nos. 12/824,215, 13/585,806 and 13/715,884. While described as part of the printed circuit board 32, electronic components 40 can optionally reside on the substrate 22 of the platform assembly 20 with the LEDs 24 as provided in some of the figures without falling outside the scope of this disclosure.

The components 40 are electrically connected to conductive elements 48, 50 and 52. In one embodiment as shown in the figures at the second end 38 first and second conductive elements 48 and 50 are on opposite sides of a head portion 54 of the printed circuit board 32 and are contoured with rib elements 56. The third conductive element 52 in one embodiment has a slot 58 therein and in a preferred embodiment has a pin element 60 extending from the slot 58.

A base element 62 is presented having a body 64 with a first annular flange 66 having a slot 67 therein for receiving the circuit board 32. Telescoping away from the first annular flange 66 is a second annular flange 68 that also has a slot 70 therein for receiving the circuit board 32. In one embodiment the diameter of the second annular flange 68 is greater than the diameter of the first annular flange 66 where the width of the circuit board coincides with the diameters of the annular flanges 66 and 68.

A stop element 72 extends from the second annular flange 68 and has an outer periphery 74 contoured to align with the exterior of the heat sink 12 to provide an aesthetically pleasing appearance to an end user. The stop element 72 has a central opening 75 for receiving the circuit board 32 such that the circuit board 32 can be disposed therethrough. In a preferred embodiment the surface adjacent the annular flanges 66 and 68 have a plurality of spaced apart grooves 76 that can matingly receive similar grooves on a heat sink 12 to provide a secured connection between the base element 62 and the heat sink 12 and providing undesired rotation.

A threaded section 78 extends from the stop element 72 having a diameter less than the diameter of the stop element 72. The threaded section 78 includes threads 80 at the end opposite the stop element 72 and a slot 82 through this threaded end partially through the threaded section 78. The threaded section 78 additionally has an opening 84 disposed therein for receiving the printed circuit board and is of size and shape to partially receive the head portion 54 of the printed circuit board 32. In particular the first and second conductive elements 48 and 50 are disposed through the slot 82 of the threaded section and engage the slot such that when pulled against the threaded section 78 the rib elements 56 of the first and second conductive elements 48 and 50 align with and become part of the threads 80 of the threaded section 78.

As shown in the figures a screw cap 86 is presented having an opening 88 for receiving the threaded section 78 of the base element 62. The screw cap includes a threaded section 90 and electrical connector 92 as is known in the art for threadably securing the screw cap 86 and thus assembly 10 to a socket. In this manner as the threaded section 90 of the screw cap 86 is threaded into the threaded section 78 of the base element 62 the first and second conductive elements 48 and 50 engage the screw cap 86 to provide an electrical connection.

As the screw cap 86 is tightened the screw cap 86 engages the stop element 72 preventing continuing movement and screwing. At this point the pin element 60 of the circuit board 32 engages the electrical connector 92 of the screw cap 86. While the pin element 60 in one embodiment does not requirement soldering, in another embodiment to present an even better electrical connection soldering can be performed. Thus an additional electrical connection is provided such that when the fully assembled assembly 10 is screwed fully into a socket three points of electrical connection are provided with either requiring only one or no soldering between electrical components and instead only press fits are presented.

In operation once the heat sink 12 is manufactured the platform assembly 20 is secured thereto with the electrically conductive device 28 electrically connected to the platform assembly and LEDs 24 thereon and disposed through the opening 26 in the platform assembly. The bulb assembly is then secured within the openings 30 of the electrically conductive device and press fit onto the heat sink 12.

Next the printed circuit board 32 is inserted into the base element 62 with the tongue elements 33a first being disposed through the opening 88 of the screw cap 86 and then the opening 84 of the threaded section 78 and so on until the head portion 54 engages the threaded section 78 of the base element 62 after sliding through and being within the slots 82 of the threaded section 78. The screw cap 86 can then be threaded onto the threaded section 78 of the base element 62 until engaging the stop element 72 of the base element 62. At this point the first and second conductive elements 48 and 50 engage the screw cap 86 and the pin element 60 engages the electrical connector 92.

At this point the tongue elements 33a of the circuit board 32 are then inserted into the sockets 31 of the electrically conductive device and snapped into place. This causes an electrical connection between the leads in the sockets 31 and the leads 33b in the tongue elements 33a to electrically connect the LEDs 24 and the printed circuit board 32. Then, because the pin element 60 and first and second conductive elements 48 and 50 are electrically connected to the screw cap 86, when the assembly 10 is screwed into a socket and an electrical input, such as an AC input or even AC input from a dimming circuit are provided, the input is conveyed through the electrical components 40 to cause the LEDs 24 to emit light. This is done without the need to solder or while minimizing soldering steps.

Thus, once assembled no additional manufacturing steps need to be undertaken. In particular the need for soldering is either eliminated or minimized as the electrical connections are made during the assembling process typically making soldering completely unnecessary. This also presents a manufacturing process that is more easily automated, faster and consequently less expensive. Therefore, at the very least all of the stated objects have been met.

What is claimed:

1. An light emitting diode lighting assembly comprising:
a substrate having a plurality of light emitting diodes disposed thereon and having a socket extending from a side of the substrate opposite the light emitting diodes;
a heat sink engaging the substrate such that heat from the substrate is conveyed from the substrate through the heat sink;
said heat sink extending from a first end adjacent the substrate to a second end, and having a channel extending from the first end to
the second end for receiving the socket such that the socket is disposed through the channel;
a printed circuit board having a plurality of electronic components thereon for driving the light emitting diodes disposed on the substrate and having an electrical lead disposed within the socket to provide an electrical connection between the printed circuit board and the substrate;
a screw cap for insertion into an electrical socket electrically connected to the printed circuit board by engaging a conductive element of a head portion of the printed circuit board to form a light emitting diode lighting assembly.

2. The light emitting diode lighting assembly of claim 1 wherein the base of the printed circuit board is threadably engaging and connected to the screw cap.

3. The light emitting diode lighting assembly of claim 1 further comprising a base element having an annular flange having a slot for receiving the printed circuit board therein, said annular flange disposed through and extending into the channel of the heat sink.

4. The light emitting diode lighting assembly of claim 3 wherein the base element has a stop element having a diameter larger than the diameter of the annular flange and engages the heat sink.

5. The light emitting diode lighting assembly of claim 4 wherein the base element has a threaded section extending from the stop element opposite the direct of the annular flange and having a slot disposed therein that receives the head portion of the printed circuit board.

6. The light emitting diode lighting assembly of claim 5 wherein the conductive element of the head portion of the printed circuit board is threaded to matingly match threads of the threaded section so that the screw cap simultaneously threadably engages the base element and the conductive element of the printed circuit board to provide a threadable and electrical connection between the screw cap and the printed circuit board.

7. The light emitting diode lighting assembly of claim 1 wherein the substrate is a printed circuit board.

8. A method of manufacturing a light emitting diode lighting assembly, steps comprising:
securing a substrate to a heat sink;
said substrate having a plurality of light emitting diodes disposed thereon and having a socket extending from a side of the substrate opposite the plurality of light emitting diodes;
said heat sink extending from a first end adjacent the substrate to a second end and having a channel extending from the first end to the second end for receiving the socket such that the socket is disposed through the channel when the substrate is secured to the heat sink;
disposing a printed circuit board having a plurality of electronic components thereon for driving the light emitting diodes disposed on the substrate, and having an electrical lead, through a base element until a head portion of the printed circuit board engages a threaded section of the base element;
inserting the electrical lead of the printed circuit board into the socket of the substrate to provide an electrical connection between the printed circuit board and the substrate; and
threading a screw cap onto the threaded section of the base element and head portion of the printed circuit board to provide an electrical connection between the screw cap and the plurality of light emitting diodes to form a light emitting diode lighting assembly.

9. The method of claim 8 wherein when the electrical lead of the printed circuit board is inserted into the socket of the substrate the base element engages the heat sink.

10. The method of claim 8 wherein when the head portion of the printed circuit board engages the base element, threads on the printed circuit board align with threads of the base element.

11. The method of claim 10 wherein the threads on the printed circuit board are conductive elements that provide an electrical pathway between the screw cap and the printed circuit board.
